(19) United States
(12) Patent Application Publication
(10) Pub. No.: US 2019/0224584 A1
(43) Pub. Date: Jul. 25, 2019

(54) PROCESS FOR MAKING SPRAY DRIED COMPOSITIONS AND SPRAY DRYING APPARATUS

(71) Applicant: Capsugel Belgium NV, Bornem (BE)

(72) Inventors: Daniel E. Dobry, Bend, OR (US); Richard F. Falk, III, Bend, OR (US); Philip Glover, San Diego, CA (US); Travis L. Harrer, Bend, OR (US); Hannah M. Sullivan, Bend, OR (US)

(73) Assignee: Capsugel Belgium NV, Bornem (BE)

(21) Appl. No.: 16/338,677

(22) PCT Filed: Sep. 15, 2017
(86) PCT No.: PCT/IB2017/055610

§ 371 Date: Apr. 1, 2019

Related U.S. Application Data
(60) Provisional application No. 62/407,943, filed on Oct. 13, 2016.

(51) Int. Cl. B01D 1/18; F26B 3/12; B01D 1/14; B01J 2/04

(52) U.S. Cl. CPC B01D 1/18; B01J 2/04; B01D 1/14; F26B 3/12

(57) ABSTRACT

The instant disclosure provides a process for making spray dried compositions and a spray drying apparatus. A relatively small, compound spray dryer is provide with an appropriately sized aspect ratio of height to diameter to allow sufficient drying time for typically sized spray dried dispersion particles intended for solid dosage form applications. The dryer is further designed to provide an amount of drying recirculation that serves to rapidly mix incoming hot drying gas to eliminate hot regions on the dryer walls.

The present application relates to a process for making spray dried compositions and a spray drying apparatus.

### BACKGROUND

Conventional spray-drying processes require a drying chamber of a relatively large diameter to enable drying at the desired throughput of fluid feed stock. Spray dryers are typically designed and operated conservatively to minimize risk related to failure of the material to adequately dry within the chamber. Inherent to that approach are inefficiencies: excessively large drying chambers to ensure particles are dry prior to impacting an internal surface and low liquid throughput. Both of these inefficiencies can increase the total cost of manufacture (increased capital cost for excessively large dryers) and increased operating costs for low throughput operation. Thus, an appropriately sized dryer providing the minimal dimensions that still allows sufficient drying time for target product properties operated at the maximum possible throughput would help address this current deficiency with spray drying from commercial spray dryers.

### SUMMARY

A process for making a spray dried composition is provided comprising the following steps. A spray solution is provided comprising a solute and a solvent. A drying chamber is provided having a chamber volume, an inlet end and an outlet end, the drying chamber including an atomizer located proximate the inlet end, and the drying chamber having an exterior wall extending from the inlet end toward the outlet end and radially spaced apart from the atomizer. A drying gas is introduced into the drying chamber. The spray solution is directed to the atomizer at a feed rate of greater than 1 kg/hr, and the spray solution is atomized into the drying chamber to form droplets. The solvent is removed from the droplets to form the composition. At least a portion of the drying gas is recirculated within the drying chamber. In addition, the drying chamber defines a height H between the inlet end and the outlet end, and a width W such that the drying chamber has an aspect ratio of H to W of at least 4. The drying chamber has a tapered cone portion proximate the outlet end, the exterior side wall of the tapered cone portion defining a cone angle θ relative to a center axis Z extending between the inlet end and the outlet end of the drying chamber, the cone angle θ being less than 40°. In addition, the ratio of a spray solution evaporation rate to the drying chamber volume is greater than 1 kJ/sec*m³.

In one embodiment, the drying chamber has an aspect ratio of at least 4.5.

In one embodiment, the ratio of the spray solution evaporation rate to the chamber volume is at least 3 kJ/sec*m³, is at least 5 kJ/sec*m³, may be at least 8 kJ/sec*m³, and may be at least 12 kJ/sec*m³.

In one embodiment, the cone angle θ is less than 25°, and may be less than 15°.

In one embodiment, the drying chamber volume is less than 1 m³, may be less than 0.8 m³, and may be less than 0.6 m³.

In one embodiment, the drying chamber volume is at least 0.1 m³, may be at least 0.2 m³, and may be at least 0.3 m³.

In one embodiment, the drying chamber width is less than 0.75 m, and may be less than 0.5 m.

In one embodiment, the drying chamber width is at least 0.25 m, and may be at least 0.4 m.

In one embodiment, the solvent comprises at least 60 wt % of a volatile organic solvent.

In one embodiment, the solvent consists essentially of a volatile organic solvent.

In one embodiment, the composition has a D50 of greater than 20 μm, and the spray solution flow rate is at least 15 kg/hr, and may be at least 25 kg/hr, and even at least 30 kg/hr.

In one embodiment, the solvent consists of water, the composition has a D50 less than 10 μm, and the spray solution flow rate is at least 1 kg/hr, and may be at least 2 kg/hr, and even at least 3 kg/hr.

In one embodiment, the drying gas inlet is spaced apart from the exterior wall by a radial distance R, the radial distance R being perpendicular to a center of axis of the drying chamber, and the radial distance R is at least 25% of one half of the maximum chamber width W, and may be at least 30% of one half of the width W, and may be at least 40% of one half of the width W.

In one embodiment, a degree of recirculation of drying gas within the drying chamber determined at a distance of 50% of the height H from the top of the drying chamber is at least 0.5, may be at least 1, and may be at least 1.5.

In one embodiment, the solute is an active agent.

In one embodiment, the spray solution further comprises an excipient.

In one embodiment, the composition comprises a spray dried dispersion comprising the active agent and an excipient.

In one embodiment, a relatively small, compact spray dryer is provided with an appropriately sized aspect ratio of height to diameter to allow sufficient drying time for typically-sized spray dried dispersion particles intended for solid dosage form applications. The dryer is further designed to provide an amount of drying recirculation that serves to rapidly mix incoming hot drying gas to eliminate hot regions on the dryer walls. This dryer allows manufacture of typical spray dried dispersion powders within a drying chamber that is significantly smaller in diameter and volume compared with a conventional commercially-available spray dryer, but enables throughput values as high as three times that of the comparable commercially-available spray dryer.

It is to be understood that both the foregoing general description and the following detailed description are exemplary and explanatory only and are not restrictive of the claimed subject matter.

### BRIEF DESCRIPTION OF THE DRAWING

FIG. 1 is a schematic view of a spray-drying apparatus.

FIG. 2 is an enlarged cross-sectional view of one embodiment of a drying chamber.

### DETAILED DESCRIPTION

Various embodiments of spray-drying processes and their associated apparatus are disclosed herein. The following description is exemplary in nature and is not intended to limit the scope, applicability, or configuration of the invention in any way. Various changes to the described embodiment may be made in the function and arrangement of the elements described herein without departing from the scope of the invention.

### Definitions

As used herein, reference to an element by the indefinite article “a” or “an” does not exclude the possibility that more than one of the element is present, unless the context clearly requires that there is one and only one of the elements. The indefinite article “a” or “an” thus usually means “at least one.” The disclosure of numerical ranges should be understood as referring to each discrete point within the range, inclusive of endpoints, unless otherwise noted. The term “about” as used in the disclosure of numerical ranges indicates that deviation from the stated value is acceptable to the extent that the deviation is the result of measurement variability and/or yields a product of the same or similar properties.

As used herein, “w/w %” and “wt %” means by weight as a percentage of the total weight.

As used herein, “D50” means for particle size distributions the diameter where half of the sample volume is less than that diameter. Similarly, “D90” means that 90 percent of the sample volume is is less than the D90 diameter value, and “D10” means that 10 percent of the sample volume is less than the D10 diameter value. These values are obtained from measurements using a Malvern Mastersizer.

Unless otherwise indicated, all numbers expressing quantities of agents, properties such as molecular weight, percentages, measurements, distances, ratios, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

### Spray Drying Process and Apparatus

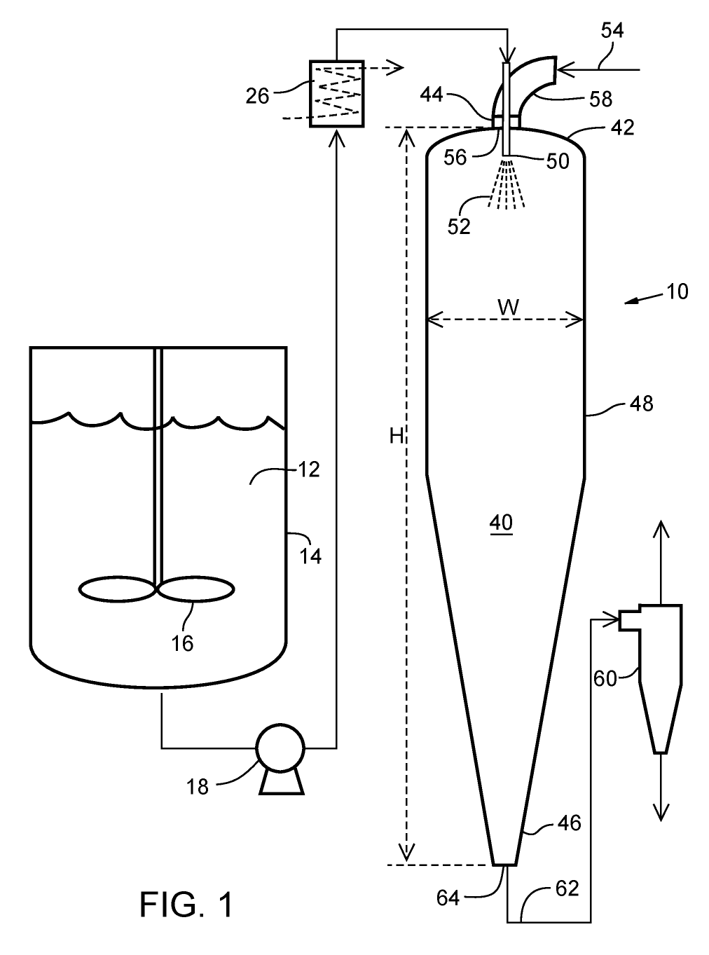

As shown in FIG. 1, spray-drying apparatus 10 can comprise a drying chamber 40, an atomizer 50, and a particle collection member 60. In operation, a spray solution is delivered to the atomizer 50 and sprayed as droplets 52 into chamber 40. Drying gas 54 enters the drying chamber through inlet 56 and mixes with the droplets 52, causing the solvent to evaporate from the droplets to produce a powder. Powder exits the drying chamber 40 at the outlet 64 and is collected in the particle collection member 60.

In one embodiment, the spray-drying apparatus 10 can be utilized as follows. A spray solution 12 can be formed by mixing a solute with a solvent. In one embodiment, the spray solution may be stored in a feed tank 14. The spray solution may be kept homogenous using a mixing means 16. In another embodiment, the spray solution may be prepared continuously.

As used herein, the term “spray solution” means a fluid composition comprising a solute and a solvent. The term “solute” means a material that is desired to be spray dried. In one embodiment, the solute comprises at least one active agent. In another embodiment, the solute comprises at least one excipient. In still another embodiment, the solute comprises a mixture of at least one active agent and at least one excipient. While the term “solution” is used, it is to be understood that the term spray solution as used herein also encompasses mixtures comprising components that are at a concentration that exceeds their solubility in the solvent at the temperature of the fluid in the feed tank, and which therefore may be characterized as suspensions, emulsions, or dispersions.

In one embodiment, the spray solution comprises an active agent and a solvent. In another embodiment, the spray solution comprises an excipient and a solvent. In still another embodiment, the spray solution comprises an active agent, at least one excipient, and a solvent. The spray solution can include, for example, mixtures, solutions, and/or suspensions. For example, in one embodiment, the active agent can be dissolved in the solvent. In another embodiment, a portion of the active agent can be suspended or not dissolved in the solvent. In another embodiment, the active agent can be dissolved in the solvent, while a portion of an excipient is dissolved in the solvent. In another embodiment, a portion of the active agent, a portion of an excipient, or a portion of both an active agent and an excipient can be suspended or not dissolved in the solvent.

In one embodiment, the spray solution consists essentially of an active agent, at least one excipient, and a solvent. In still another embodiment, the spray solution consists of an active agent, at least one excipient, and a solvent. In yet another embodiment, the spray solution consists of particles of active agent suspended in a solution of at least one excipient dissolved in the solvent. In yet another embodiment, the spray solution also contains particles of one or more excipients suspended in the solution. It will be recognized that in such spray solutions, a portion of the active agent and the one or more excipients may dissolve up to their solubility limits at the temperature of the spray solution.

As used herein, “active agent” means an active pharmaceutical ingredient, drug, medicament, pharmaceutical, therapeutic agent, nutraceutical, nutrient, or other compound. The active agent may be a “small molecule,” generally having a molecular weight of 2000 Daltons or less. The active agent may also be a “biological active.” Biological actives include proteins, antibodies, antibody fragments, peptides, oligoneucleotides, vaccines, and various derivatives of such materials. In one embodiment, the active agent is a small molecule. In another embodiment, the active agent is a biological active. In still another embodiment, the active agent is a mixture of a small molecule and a biological active. In yet another embodiment, the compositions made by certain of the disclosed processes comprise two or more active agents.

Non-limiting examples of active agents according to the disclosure include but are not limited to drugs, supplements, dietary supplements, such as vitamins or provitamins A, B, C, D, E, PP and their esters, carotenoids, anti-radical substances, hydroxyacids, antiseptics, molecules acting on pigmentation or inflammation, biological extracts, antioxidants, cells and cell organelles, antibiotics, macrolides, antifungals, itraconazole, ketoconazole, antiparasitics, antimalarials, adsorbents, hormones and derivatives thereof, nicotine, antihistamines, steroid and non-steroid anti-inflammatories, ibuprofen, naproxen, cortisone and derivatives thereof, anti-allergy agents, antihistamines, analgesics, local anesthetics, antivirals, antibodies and molecules acting on the immune system, cytostatics and anticancer agents, hypolipidemics, vasodilators, vasoconstrictors, inhibitors of angiotensin-converting enzyme and phosphodiesterase, fenofibrate and derivatives thereof, statins, nitrate derivatives and anti-anginals, beta-blockers, calcium inhibitors, anti-diuretics and diuretics, bronchodilators, opiates and derivatives thereof, barbiturates, benzodiazepines, molecules acting on the central nervous system, nucleic acids, peptides, anthracenic compounds, paraffin oil, polyethylene glycol, mineral salts, antispasmodics, gastric anti-secretory agents, clay gastric dressings and polyvinylpyrrolidone, aluminum salts, calcium carbonates, magnesium carbonates, starch, derivatives of benzimidazole, and combinations of the foregoing.

As used herein, the term “solvent” means water or an organic compound that can be used to dissolve or suspend the solute. In one embodiment, the solvent is a volatile organic solvent, having an ambient-pressure boiling point of 150° C. or less. In another embodiment, the solvent has an ambient-pressure boiling point of 100° C. or less. Suitable solvents can include water; alcohols such as methanol, ethanol, n-propanol, isopropanol, and butanol; ketones such as acetone, methyl ethyl ketone and methyl isobutyl ketone; esters such as ethyl acetate and propyl acetate; and various other solvents, such as tetrahydrofuran, acetonitrile, methylene chloride, toluene, and 1,1,1-trichloroethane. Lower volatility solvents such as dimethylacetamide or dimethylsulfoxide can also be used, generally in combination with a volatile solvent. Mixtures of solvents, such as 50% methanol and 50% acetone, can also be used, as can mixtures with water. In one embodiment, the solvent is at least 60 wt % volatile organic solvent, may be at least 75 wt % volatile organic solvent, and may be at least 90 wt % volatile organic solvent. In one embodiment, the solvent consists of a volatile organic solvent. In one embodiment, the solvent is a volatile organic solvent selected from the group consisting of methanol, ethanol, isopropanol, acetone, methyl ethyl ketone, and ethyl acetate.

As used herein, the term “excipient” means a substance that may be beneficial to include in a composition with an active agent. The term “excipient” includes inert substances as well as functional excipients that may result in beneficial properties of the composition. Exemplary excipients include but are not limited to polymers, sugars, salts, buffers, fats, fillers, disintegrating agents, binders, surfactants, high surface area substrates, flavorants, carriers, matrix materials, and so forth.

The spray solution can be delivered to an atomizer 50 via a pump 18 or other device. The spray drying apparatus may include a heat exchanger 26 to increase the temperature of the spray solution prior to atomization. The spray drying apparatus is capable of operating at high spray solution flow rates. In one embodiment, when the spray drying process is used to manufacture particles from organic solvent having a particle size of D50 greater than 20 μm, the spray solution flow rate is at least 15 kg/hr, and may be at least 25 kg/hr, and even at least 30 kg/hr. The high spray solution flow rate contributes to the high efficiency of the spray drying apparatus.

In another embodiment, when the spray drying process is used to manufacture particles from aqueous solvent having a particle size of D50 less than 10 μm, the spray solution flow rate is at least 1 kg/hr, and may be at least 2 kg/hr, and even at least 3 kg/hr.

Atomizer 50 atomizes the spray solution into the drying chamber 40 in the form of droplets 52. Any atomizer capable to breaking apart the spray solution into droplets may be used. Exemplary atomizers include pressure-swirl, two-fluid, and flash nozzles. A preferred atomizer is pressure-swirl.

In one embodiment, the atomizer is chosen to form droplets of appropriate size based on the end use. For example, particles to be used for delivery to the lungs will generally have a D50 of less than 10 μm, and therefore the atomizer should be capable of forming droplets of less than about 20 μm. Particles to be used in solid oral dosage forms will be larger, e.g., D50 of from 20 μm to 100 μm, and therefore typical droplet size will range from about 30 to 120 μm.

Drying gas 54 flows through a drying-gas conduit 58, which is in fluid communication with the first end 42 of drying chamber 40. The drying gas may be virtually any gas, but to minimize the risk of fire or explosions due to ignition of flammable vapors, and to minimize undesirable oxidation of the active agent or other excipients, an inert gas such as nitrogen, nitrogen-enriched air, helium, or argon is utilized.

Generally, the temperature and flow rate of the drying gas should be chosen so that the droplets of spray solution are dry enough by the time they reach an interior wall of the apparatus that, at least on the particle surface, they are essentially solid, form a fine powder, and do not stick to the apparatus wall. The actual length of time to achieve this level of dryness depends on the size of the droplets and the conditions at which the process is operated. The temperature of the drying gas at the gas inlet 56 of chamber 40 is typically from 20° to 200° C.

In one embodiment, when the spray drying process is used to manufacture particles from organic solvent having a particle size D50 of greater than 20 μm, and the spray solution flow rate is at least 15 kg/hr, then the drying gas will have a flow rate of at least 1500 g/min, may be at least 2000 g/min, and may be at least 2500 g/min. The temperature of the drying gas at the gas inlet of apparatus 10 may be at least 100° C., may be at least 110° C., or at least 120° C.

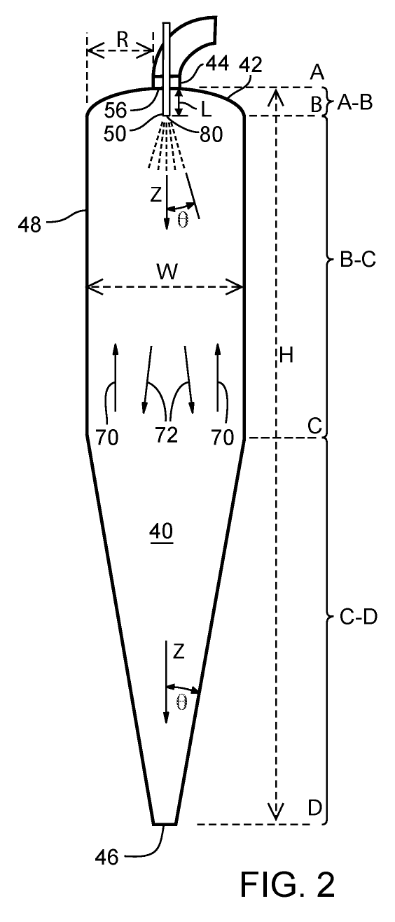

In one embodiment, the drying-gas conduit 58 contains a gas disperser 44, such as a mesh, screen, or perforated plate that results in substantially parallel flow of drying gas when the drying gas 54 enters the drying chamber 40. As used herein, “substantially parallel flow” means that the velocity vector of the drying gas 54 averaged over the cross-section of the inlet 56 of the drying chamber 40 is essentially parallel to the center axis Z of drying chamber 40 and is substantially towards the second end 46 of drying chamber 40. Drying gas continues into the drying chamber generally in the direction of the center Z axis as shown by flow lines 72 in FIG. 2.

The drying gas is combined with the droplets 52 in the drying chamber 40. In the drying chamber 40, at least a portion of the solvent is removed from the droplets 52 to form an exiting fluid comprising evaporated solvent and drying gas and a plurality of at least partially dried particles that exit through the exit conduit 62. The term “exiting fluid” refers to any fluids, particles, or combinations of fluids and particles that exit the drying chamber 40. The temperature of the product particles, drying gas, and evaporated solvent in the exiting fluid typically ranges from 0° C. to 100° C.

As shown in FIGS. 1 and 2, drying chamber 40 has a first end 42 and a second end 46. First end 42 can be an inlet for receiving the atomizer and can be coupled to the drying gas conduit 58 for receiving the drying gas 54. Second end 46 can be an outlet 64 that can be coupled to an exit conduit 62, and then to a particle collection member 60 or other such device to receive and collect the particles as they exit drying chamber 40. The interior volume V of drying chamber 40 can be defined by one or more side walls 48 that extend between first and second ends 42, 46. If drying chamber 40 comprises a single integral structure, a single side wall 48 can extend from first end 42 to second end 46. Alternatively, drying chamber 40 can be formed of sections that include multiple side walls 48 that are coupled together to form a single drying chamber. The three sections can be separate side walls 48 that are coupled or connected together in any conventional manner (e.g., mechanically and/or chemically). Alternatively, the three sections can be integrally formed of a single side wall member.

In the embodiment of FIG. 2, the apparatus has a generally cylindrical shape. The first end 42 of the drying chamber is located at Position A. The second end 46 of the drying chamber is located at Position D. The cylindrical walls 48 of the drying chamber define an interior of the drying chamber having a center axis Z. The atomizer 50 is located at or near the first end 42 of the drying chamber. In one embodiment, the top portion (Section A-B) is a top rounded section. Other embodiments may have a horizontally flat top portion (Section A-B). The drying chamber comprises a cylindrical portion of generally constant width at Section B-C. The drying chamber further comprises a tapered portion Section C-D extending to the second end 46 that is narrowest at the second end (46, Position D), and widest at Position C. The side wall of the tapered cone portion C-D defines a cone angle θ relative to the center axis Z of the drying chamber. In one embodiment, the cone angle θ is less than 40° , may be less than 25° , and may be less than 15°.

The drying chamber has a relatively large aspect ratio. The aspect ratio of the height H between the first end 42 and the second end 46 (that is, the distance between Positions A and D) to the maximum width W between opposing internal surfaces of the interior of the drying chamber is at least 4, and may be at least 4.5. By providing a drying chamber that has a width that is significantly smaller than its height, drying chamber volume and thus, residence time in the drying chamber can be greatly reduced. The substantial height (relative to the width) provides enough time for the droplets or particles to be sufficiently dried before exiting the drying chamber.

The tall aspect ratio enables the operation of an extremely efficient spray dryer in which the solvent evaporative capacity is maximized relative to the drying chamber volume. The spray drying chamber defines an internal volume V. A measure of efficiency of the spray dryer may be determined by the ratio of the rate at which solvent can be evaporated to the chamber volume. In one embodiment, the ratio of the evaporation rate of spray solution to the chamber volume is at least 1 kJ/sec*m³. In another embodiment, the ratio of the evaporation rate of spray solution to the chamber volume may be at least 3 kJ/sec*m³, may be at least 5 kJ/sec*m³, or may be at least 8 kJ/sec*m³. In one preferred embodiment, the ratio of the spray solution feed rate to the chamber volume is at least 12 kJ/sec*m³. The ratio of the evaporation rate of spray solution to chamber volume may be determined by calculating the energy necessary (in kJ/sec) to evaporate the mass flow rate of solvent entering the spray dryer and dividing that by the volume of the spray dryer.

In order to minimize the exposure of the active in the droplets and particles to elevated temperature, the chamber and the drying gas inlet are configured to provide at least a minimum degree of recirculation of drying gas within the drying chamber. Several dryer dimensions and attributes of the dryer shape directly influence the degree of recirculation. These include, but are not limited to the dryer aspect ratio (H/W), the diameter of the gas inlet 56, and the ratio of the diameter of the gas inlet 56 to the dryer width (W). Recirculation is produced by these combinations of geometric attributes by creating an abrupt expansion of the drying gas inlet (42) into the chamber of width W which in turn, produces boundary layer separation of the inlet drying gas from the adjacent walls. This separated flow is equivalently termed “recirculation”. By “degree of recirculation” is meant the ratio of the backflow (shown by flow lines 70 in FIG. 2) of drying gas determined at a distance of 50% of the height H from the first end of the drying chamber at 42 to the inlet drying gas flow entering the dryer at inlet 56. The degree of recirculation may be determined by numerical simulation using computational fluid dynamics (CFD) models of the dryer. CFD models were developed and simulations performed using FLUENT commercially-available CFD Software sold by Ansys Inc. The degree of recirculation could be measured experimentally using particle image velocimetry (PIV). In one embodiment, the degree of recirculation is at least 0.5, may be at least 1, and may be at least 1.5.

In one embodiment, a chamber having the required degree of recirculation is provided by configuring the gas inlet 56 and spray drying chamber 40 to have a separation between the side wall 48 and the edge of the gas inlet 56. In particular, the gas inlet 56 is spaced radially apart from the sidewall 48 a distance R, where R is the distance between the edge of the gas inlet 56 and the sidewall 48 in a direction that is perpendicular to the center axis Z of the chamber. The distance R is at least 25% of one half the width W, and may be at least 30% of one half the width W, and may be at least 40% of one half the width W. In a preferred embodiment the distance R is at least 50% of one half the width W. In addition, in one embodiment, the exit 80 of the atomizer 50 is inserted into the drying chamber 40 a length L from the top of the drying chamber 40 so as to provide a separation between the exit 80 from the atomizer and the top of the drying chamber. The distance L may be at least 10% of R, at least 20% or R, or at least 30% of R.

The relatively small volume V and high gas flow rates also allows the spray drying apparatus to achieve relatively low mean residence times. As used herein, the term “mean residence time” means the ratio of the drying chamber volume V to the drying gas flow rate. In one embodiment, the mean residence time of the spray-drying apparatuses disclosed herein can be less than 20 seconds. Shorter residence times can be obtained, and are sometimes desirable, such as less than 12 seconds, less than 10 seconds, or less than 8 seconds. The reduced particle residence time for the disclosed apparatuses reduces exposure to elevated drying gas temperatures that can cause degradation of active agents or excipients, allowing heat-sensitive materials to be spray dried. For example, compounds such as DNA, proteins, or antibodies that are not stable for long periods of time in a spray-drying chamber at high temperature and humidity, can be dried using the apparatuses disclosed herein due to the order of magnitude smaller residence time.

The recirculation of drying gas within the drying chamber, and the separation of the drying gas inlet 56 from the sidewall by a distance R of at least 25% of one half of the width W, reduces the time over which droplets and particles are exposed to elevated gas temperatures that can cause degradation of active agents or excipients, allowing heat-sensitive materials to be spray dried. For example, compounds such as DNA, proteins, or antibodies that are not stable for long periods of time in a spray-drying chamber at high temperature and humidity, can be dried using the apparatuses disclosed herein.

In one embodiment, the top rounded section A-B can be 0-20 cm in height. In one embodiment, the straight section B-C is substantially cylindrical and can be 50-200 cm in height and can have a substantially constant width along its height. The contracting tapered section C-D can be 50-200 cm in height and can be narrowest at the outlet end (second end 46, Position D) and widest at a position furthest from the second end 46. Accordingly, in one embodiment, a total height of the drying chamber H can vary from 150 cm to 300 cm. In certain embodiments, the interior of the drying chamber has a volume that is 600 L or less, or even less than 400 L. In one embodiment, the drying chamber has a volume of between 300-350 L

The exiting fluid exits the drying chamber at the second end 46 through exit conduit 62, and can be directed to a particle collection member 60. Suitable particle collection members include cyclones, filters, electrostatic particle collectors, and the like. In the particle collection member 60, the evaporated solvent and drying gas 62 can be separated from the plurality of particles, allowing for collection of the particles.

An additional advantage of the spray-drying apparatuses disclosed herein is found in the collection of small particles. For spray-drying particles having diameters of less than 10 μm using conventional spray-drying equipment, collection efficiency can be particularly poor. As discussed above, the smaller volume chambers of the spray-drying apparatuses disclosed herein can allow a higher pressure drop, which will allow more efficient particle collection in a cyclone.

In one embodiment, the concentration of solvent remaining in the particles when they are collected (that is, the concentration of residual solvent) is less than 10 wt % based on the total weight of the particles (i.e., the combined weight of the particle and solvent). In another embodiment, the concentration of residual solvent in the particles when they are collected is less than 5 wt %. In yet another embodiment, the concentration of residual solvent in the particles is less than 3 wt %. In another embodiment, a drying process subsequent to the spray-drying process may be used to remove residual solvent from the particles. Exemplary processes include tray drying, fluid-bed drying, vacuum drying, and other similar drying processes.

As described above, the spray-drying apparatuses described herein are suitable for producing particles of small average diameters, such as those suitable for inhalation (e.g., D50 less than 10 μm). In other embodiments, however, the particles formed by the spray-drying apparatuses described herein can have an average diameter D50 ranging from 0.5 μm to 500 μm. In another embodiment, the particles have a diameter D50 ranging from 0.5 μm to 100 μm. In another embodiment, the particles have an average diameter D50 of greater than 10 μm. In still another embodiment, the particles have an average diameter D50 of greater than 20 μm. In still another embodiment, the particles have an average diameter D50 of greater than 30 μm.

### Spray-Dried Solid Compositions

In one embodiment, the spray-dried product formed by the spray-drying apparatus can comprise an active agent. In another embodiment, the spray-dried product formed by the spray-drying apparatus can comprise an excipient. In another embodiment, the spray-dried product formed by the spray-drying apparatus can comprise an active agent and at least one excipient.

The excipient can be used to dilute the active and/or modify the properties of the composition. For instance, for inhalation applications, an excipient may improve or slow the rate of particle dissolution in lung fluid, bronchial mucus, or nasal mucus, reduce particle agglomeration, and/or improve reproducibility of the emitted dose. Examples of excipients include but are not limited to synthetic polymers, polysaccharides, derivatized polysaccharides, sugars, sugar alcohols, organic acids, salts of organic acids, inorganic salts, proteins, amino acids, phospholipids, and pharmaceutically acceptable salt forms, derivatives, and mixtures thereof. In another embodiment, the excipient is selected from polyvinyl pyrrolidone (PVP), polyethyleneoxide (PEO), poly(vinyl pyrrolidone-co-vinyl acetate), polymethacrylates, polyoxyethylene alkyl ethers, polyoxyethylene castor oils, polycaprolactam, polylactic acid, polyglycolic acid, poly(lactic-glycolic)acid, lipids, cellulose, pullulan, dextran, maltodextrin, hyaluronic acid, polysialic acid, chondroitin sulfate, heparin, fucoidan, pentosan polysulfate, spirulan, hydroxypropyl methyl cellulose (HPMC), hydroxypropyl cellulose (HPC), carboxymethyl ethylcellulose (CMEC), hydroxypropyl methylcellulose acetate succinate (HPMCAS), ethyl cellulose, cellulose acetate, cellulose butyrate, cellulose acetate butyrate, dextran polymer derivatives, trehalose, glucose, sucrose, raffinose, lactose, mannitol, erythritol, xylitol, polydextrose, oleic acid, citric acid, tartaric acid, edetic acid, malic acid, sodium citrate, sodium bicarbonate, albumin, gelatin, acacia, casein, caseinate, glycine, leucine, serine, alanine, isoleucine, tri-leucine, lecithin, phosphatidylcholine, and pharmaceutically acceptable forms, derivatives, and mixtures thereof. In one embodiment, the excipient is selected from lactose, mannitol, trehalose, sucrose, citric acid, leucine, glycine, dextran, oleic acid, and pharmaceutically acceptable salt forms, derivatives, and mixtures thereof. In still another embodiment, the excipient is selected from lactose, mannitol, trehalose, sucrose, citric acid, leucine, glycine, and pharmaceutically acceptable salt forms, derivatives, and mixtures thereof.

The apparatus can be used to form a wide variety of pharmaceutical compositions, including, but not limited to, spray dried amorphous active agentsagent, spray dried solid amorphous dispersions, amorphous active agent absorbed to a high-surface area substrate, spray dried crystalline active agent in a matrix, microparticles, nanoparticles, and spray-dried excipients.

It should be understood that the embodiments described herein are not limited thereto. Other embodiments of the present disclosure will be apparent to those skilled in the art from consideration of the specification and practice of the disclosed embodiments. The following examples should be considered as exemplary only, with a true scope and spirit of the present disclosure being indicated by the following claims.

### EXAMPLES

### Examples 1-3

Example 1 was prepared as follows. A spray solution was prepared by adding 1600 g of phenytoin to 48.65 kg of acetone in a mixing tank. The mixing tank was stirred until the phenytoin had dissolved in the solvent. 4800 g of the polymer hydroxypropylmethylcellulose acetate succinate (HPMCAS, AQOAT H grade available from Shin Etsu) was then added to the mixing tank, and was stirred until the spray solution appeared to be homogeneous. The resulting spray solution was pumped at a spray solution flow rate of 18 kg/hr to a Spraying Systems SK-78-16 pressure swirl atomizer. Nitrogen was used as the drying gas at a flow rate of 1650 g/min and having a temperature at the drying chamber inlet of 145° C. The spray solution was atomized at 750 psig. The drying chamber had a height H of 237 cm, and maximum width W of 50 cm, and a volume V of 317 liters. The spray drying apparatus operated at an evaporative efficiency of 7.4 kJ/sec/m³. The yield of spray dried powder was 95.1%. Additional details regarding Example 1 are provided in Table 1.

Examples 2 and 3 were prepared in the same manner as Example 1 but with the conditions shown in Table 1.

TABLE 1

| Spray Reference | Example 1 | Example 2 | Example 3 |
|---|---|---|---|
| Atomizer | SK 78-16 | SK 78-16 | SK 77-21 |
| SDD Composition | 25% Phenytoin | 25% Phenytoin | 25% Phenytoin |
| | 75% HPMCAS-H | 75% HPMCAS-H | 75% HPMCAS-H |
| Solids wt % | 11.65 | 11.65 | 11.65 |
| Atomization Pressure (Psi) | 750 | 750 | 650 |
| Solution Flow (g/min) | 300 | 300 | 500 |
| (kg/hr) | 18 | 18 | 30 |
| Inlet Temp (° C.) | 145 | 113 | 137 |
| Outlet Temp (° C.) | 42 | 42 | 45 |
| Drying Gas Flow Rate (g/min) | 1650 | 2500 | 3100 |
| Average Residence time (s) | 11.4 | 7.6 | 6 |
| Evaporative Efficiency (kJ/sec/m\hat{ }3) | 7.4 | 7.4 | 12.3 |
| Wet Yield (%) | 95.1 | 95.5 | 100 |
| Residual solvent (wt %) | 3.31 ± 1.33 | 2.96 ± 0.16 | 4.60 ± 0.17 |
| Bulk/Tap Density (g/cc) | 0.12/0.22 | 0.14/0.25 | 0.15/0.26 |
| Particle D10/D50/D90 (μm) | 14/40/87 | 11/40/86 | 15/54/142 |

### Examples 4-6

Example 4 was prepared as follows. A spray solution was prepared by adding 47.99 g of Leucine to 4543.9 g of deionized water in a flask. The flask was stirred until the Leucine had dissolved in the solvent. Next 212.27 g of Trehalose Dihydrate was then added to the flask, and was stirred until the spray solution appeared to be homogeneous. The resulting spray solution was pumped at a spray solution flow rate of 18 g/min to a Spraying Systems two fluid atomizer (Liquid cap ID: 1650, Air cap ID: 120). Nitrogen was used as the drying gas at a flow rate of 1250 g/min and having a temperature at the drying chamber inlet of 135° C. The spray solution was atomized with nitrogen stream at 50 psig. The drying chamber had a height H of 237 cm, and maximum width W of 50 cm, and a volume V of 317 liters. Additional details regarding Example 4 are provided in Table 2.

Examples 5 and 6 were prepared in the same manner as Example 4 but with the conditions shown in Table 2.

TABLE 2

| Spray Reference | Example 4 | Example 5 | Example 6 |
|---|---|---|---|
| Atomizer | SK 78-16 | SK 78-16 | SK 77-21 |
| SDD Composition | 80% Trehalose | 80% Trehalose | 80% Trehalose |
| | 20% Leucine | 20% Leucine | 20% Leucine |
| Solids wt % | 5.0 | 5.0 | 5.0 |
| Atomization Pressure | 50 | 50 | 75 |
| (Psi) | | | |
| Solution Flow (g/min) | 18 | 18 | 40 |
| (kg/hr) | 1.08 | 1.08 | 2.4 |
| Inlet Temp (° C.) | 135 | 101 | 122 |
| Outlet Temp (° C.) | 70 | 70 | 70 |
| Drying Gas Flow Rate | 1250 | 2800 | 2800 |
| (g/min) | | | |
| Evaporative Efficiency | 2.2 | 2.2 | 4.9 |
| (kJ/sec/m\hat{ }3) | | | |
| Wet Yield (%) | 82 | 81 | 82 |
| Particle D10/D50/D90 | 0.5/2.3/4.9 | 0.6/2.4/4.8 | 0.6/2.4/5.2 |
| (μm) | | | |

1. A process for making a spray dried composition, comprising the steps:
a) providing a spray solution comprising a solute and a solvent;
b) providing a drying chamber having a chamber volume, an inlet end and an outlet end, the drying chamber including an atomizer located proximate the inlet end, the drying chamber having an exterior wall extending from the inlet end toward the outlet end and radially spaced apart from the atomizer;
c) introducing a drying gas into the drying chamber;
d) directing the spray solution to the atomizer at a feed rate of greater than 1 kg/hr, and atomizing the spray solution into the drying chamber to form droplets;
e) removing the solvent from the droplets to form the composition;
wherein at least a portion of the drying gas is recirculated within the drying chamber; and
wherein
i) the drying chamber defines a height H between the inlet end and the outlet end, and a width W such that the drying chamber has an aspect ratio of H to W of at least 4;
ii) the drying chamber has a tapered cone portion proximate the outlet end, the exterior side wall of the tapered cone portion defining a cone angle 9 relative to a center axis Z extending between the inlet end and the outlet end of the drying chamber, the cone angle 9 being less than 40°:
iii) the ratio of a spray solution evaporation rate to the drying chamber volume is greater than 1 kJ/sec*m³.

2. The process of claim 1 wherein chamber has an aspect ratio of at least 4.5.

3. The process of claim 1 wherein the ratio of the spray solution evaporation rate to the chamber volume is at least 3 kJ/sec*m³.

4. The process of claim 1 wherein the cone angle θ is less than 25°.

5. The process claim 1 wherein the drying chamber volume is less than 1 m³.

6. The process of claim 1 wherein the drying chamber volume is at least 0.1 m³.

7. The process of claim 1 wherein the drying chamber width is less than 0.75 m.

8. The process of claim 1 wherein the drying chamber width is at least 0.25 m.

9. The process of claim 1 wherein the solvent comprises at least 60 wt % of a volatile organic solvent.

10. The process of claim 9 wherein the composition has a D50 of greater than 20 μm, and the spray solution flow rate is at least 15 kg/hr.

11. The process of claim 1 wherein the solvent consists of water, the composition has a D50 less than 10 μm, and the spray solution flow rate is at least 1 kg/hr.

12. The process of claim 1 wherein an exit from the atomizer is spaced apart from the exterior wall by a radial distance R, the radial distance R being perpendicular to a center of axis of the drying chamber, and the radial distance R is at least 25% of one half of the maximum chamber width W.

13. The process of claim 1 wherein a degree of recirculation of drying gas within the drying chamber determined at a distance of 50% of the height H from the top of the drying chamber is at least 0.5.

14. The process of claim 1 wherein the solute is an active agent.

15. The process of claim 1 wherein the spray solution further comprises an excipient.

16. The process of claim 1 wherein the composition comprises a spray dried dispersion comprising the active agent and an excipient.
